(19) United States
(12) Patent Application Publication
(10) Pub. No.: US 2014/0011921 A1
(43) Pub. Date: Jan. 9, 2014

(54) POLYOLEFIN COMPOSITIONS COMPRISING BIO-BASED STARCH MATERIALS

(71) Applicant: Cereplast, Inc,, (US)

(72) Inventors: Thomas F. Bash, Hawthorne, CA (US); William E. Kelly, Hawthorne, CA (US); Shriram Bagrodia, Hawthorne, CA (US); Frederic Scheer, Hawthorne, CA (US)

(73) Assignee: Cereplast, Inc,, El Segundo, CA (US)

(21) Appl. No.: 13/751,832

(22) Filed: Jan. 28, 2013

Related U.S. Application Data
(62) Division of application No. 11/838,650, filed on Aug. 14, 2007, now abandoned.
(60) Provisional application No. 60/955,538, filed on Aug. 13, 2007.

(51) Int. Cl. C08L 3/02

(52) U.S. Cl. CPC C08L 3/02
USPC 524/52; 264/328.1; 264/322; 264/540; 264/299; 264/531

(57) ABSTRACT

Polyolefin compositions and methods of making and using the polyolefin compositions are provided. In a general embodiment, the present disclosure provides a composition comprising a polyolefin, a compatibilizer, a starch and a plasticizer.

### PRIORITY CLAIM

This application is a divisional of U.S. application Ser. No. 11/838,650 filed on Aug. 14, 2007, which claims the benefit of U.S. Provisional Patent Application Ser. No. 60/955,538 filed on Aug. 13, 2007, the entire disclosures of which are hereby incorporated by reference.

### BACKGROUND

The present disclosure is directed to polyolefin compositions. More specifically, the present disclosure is directed to improved polyolefin compositions, articles produced from the polyolefin compositions and processes relating to the polyolefin compositions.

Consumer products made from plastics come in a variety of forms. Such products include, for example, toys, computer casing, DVDs, toiletries, cellular phone casings, automobile parts, etc., are greatly used nowadays. Unfortunately, the widespread and even growing use of such plastic materials for making these consumer products results in increasing dependence on fossil fuels each day. For example, the plastic materials that make up many of these consumer products require large amounts of oil for their production.

### SUMMARY

The present disclosure generally relates to polyolefin compositions and methods of making and using the polyolefin compositions. For example, the polyolefin compositions can be made using bio-based content and are more environmentally friendly. In a general embodiment, the present disclosure provides a composition comprising one or more polyolefins, one or more compatibilizers, one or more starches and one or more plasticizers.

In an embodiment, the polyolefin comprises from about 20 to about 80% by weight, the compatibilizer comprises from about 1 to about 10% by weight, the starch comprises from about 10 to about 70% by weight, and the plasticizer comprises from about 3 to about 15% by weight of the composition.

In an embodiment, the polyolefin is polyethylene, polypropylene, polybutene or combination thereof.

In an embodiment, the polyethylene is low density polyethylene, high density polyethylene, linear low density polyethylene or combination thereof.

In an embodiment, the polyethylene is virgin polyethylene, recycled polyethylene or blend of virgin polyethylene and recycled polyethylene.

In an embodiment, the polypropylene is virgin polypropylene, recycled polypropylene or blend of virgin polypropylene and recycled polypropylene.

In an embodiment, the compatibilizer is maleic anhydride grafted polypropylene, maleic anhydride grafted polyethylene, maleic anhydride grafted polybutene or combination thereof.

In an embodiment, the compatibilizer comprises maleated polypropylene with a melt flow of about 50 to about 500 g/10 minute and maleic anhydride grafting of about 0.5 to about 10 wt %.

In an embodiment, the starch is made from corn, tapioca, maize, wheat, rice or combination thereof.

In an embodiment, the plasticizer is polyethylene glycol, sorbitol, glycerine or combination thereof.

In an embodiment, the composition comprises one or more additional components such as, for example, stabilizers, colorants, antioxidants, flavorants, nanofillers, non-clay particles, glass-fiber reinforcements, anti-microbial agents, processing aids or combination thereof.

In an embodiment, the anti-microbial agents are zinc oxide, copper and copper compounds, silver and silver compounds, colloidal silver, silver nitrate, silver sulphate, silver chloride, silver complexes, metal-containing zeolites, surface-modified metal-containing zeolites or combination thereof.

In an embodiment, the metal-containing zeolites comprise a metal such as silver, copper, zinc, mercury, tin, lead, bismuth, cadmium, chromium, cobalt, nickel, zirconium and combinations thereof.

In an embodiment, the anti-microbial agents are o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol and combinations thereof.

In another embodiment, the present disclosure provides a method of making a polyolefin composition. The method comprises blending a polyolefin, a compatibilizer, a starch and a plasticizer to form a mixture.

In an embodiment, the method can further comprise extruding the blended mixture to form an extrudate.

In an embodiment, the method can further comprise shaping the extrudate to form articles such as toys, computer casing, DVDs, toiletries, combs, consumer products, cellular phone casings, bags, foam material products, packaging, automobile parts, cookware or combination thereof.

In an embodiment, the articles are made by a process such as injection molding, thermoforming, film blowing, film extrusion, blow molding, extrusion coatings, cast films, cast products or combination thereof.

In yet another embodiment, the present disclosure provides a method of making a polyolefin composition. The method comprises blending a polyolefin and a compatibilizer to form a first mixture, blending a starch and a plasticizer to form a second mixture, feeding the first mixture into a first feed of an extruder and feeding the second mixture into the extruder at a location downstream of the first feed. The second mixture is blended with the first mixture in the extruder. The method further comprises extruding the blended mixture to form an extrudate.

In an embodiment, the method comprises vacuuming the vapor phase of the blended mixture.

In an alternative embodiment, the present disclosure provides a method of making a polyolefin film. The method comprises blending a polyolefin, a compatibilizer, a starch and a plasticizer to form a mixture and forming a film from the mixture.

In an embodiment, the method can further comprise applying the film to an article comprising a material selected from the group consisting of paper, plastics, wood, composite materials or combination thereof.

An advantage of the present disclosure is to provide improved polyolefin compositions.

Another advantage of the present disclosure is to provide improved methods of making polyolefin compositions.

Yet another advantage of the present disclosure is to provide bio-based polyolefin compositions.

Still another advantage of the present disclosure is to provide improved articles comprising bio-based polyolefin compositions.

Additional features and advantages are described herein, and will be apparent from, the following Detailed Description.

### DETAILED DESCRIPTION

The present disclosure relates to polyolefin compositions and methods of making and using the polyolefin compositions. The polyolefin compositions can be made using bio-based content, which can reduce the need for fossil fuels. In a general embodiment, the present disclosure provides a composition comprising a polyolefin, a compatibilizer, a starch and a plasticizer.

There is a need to reduce our dependence on fossil fuels. The plastics industry is using about 7% of all the imported oil in the United States every year. This is a significant figure. The plastics industry in the past few years has been plagued by price fluctuations due to fossil fuels price variation. For years, the price of fossil fuels was steady allowing the plastic industry to rely on an abundant commodity at a steady price. Today, fossil fuels reserves are not as abundant as expected, costs of drilling has increased exponentially, several large Middle East countries have peaked the capacity and prices are fluctuating heavily and become very speculative. All industries dependent on fossil fuel energy are more at risk than before.

Incorporation of polymers such as starch into petroleum based polymers such as polyolefins in accordance with embodiments of the present disclosure can help to reduce our dependence on oil. The polyolefin compositions of the present disclosure can also make resins that are more environmentally friendly.

Polyolefins are typically hydrophobic in nature. Starch is typically hydrophilic. Physically blending polyolefins and starch and processing the mixture in conventional melt processing units results in an incompatible blend having poor physical/mechanical properties and poor interfacial adhesion. It has been surprisingly found that by using a novel blend of materials including (1) a compatibilizer that enhances the interfacial adhesion between polyolefins and starch and (2) a plasticizer for starch, an improved polyolefin composition was produced.

Mixing technology and unique reactive extrusion via twin screw processing can be used to form articles with the polyolefin compositions. Addition technology such as thermoforming, injection molding, blow molding, film blowing, film extrusion, stretch blow molding (SBM), extrusion coating, profile extrusion, extrusion blow molding (EBM), etc., can also be used to produce various articles made from the polyolefin compositions.

The polyolefin can be any suitable polyolefin such as, for example, polyethylene, polypropylene, polybutene or combination thereof. The polyethylenes can be low density polyethylene, high density polyethylene, linear low density polyethylene or combination thereof. The polypropylenes can be, for example, polypropylene homopolymers, polypropylene random copolymers and modified polypropylenes. Preferably, in alternative embodiments, the polypropylenes have a melt flow index of 1-100 g/10 min. The polyolefins can also be virgin polyethylene, recycled polyethylene, virgin polypropylene, recycled polypropylene or blends thereof.

As used herein, the term “compatibilizer” means a composition that can provide blending between a polyolefin and starch. For example, the compatibilizer can be maleic anhydride grafted polypropylene, maleic anhydride grafted polyethylene, maleic anhydride grafted polybutene or combination thereof. The compatibilizer can comprise maleated polypropylene with a melt flow of about 50 to about 500 g/10 minute and maleic anhydride grafting of about 0.5 to about 10 wt %.

Some non-limitative examples of suitable compatibilizers include Epolene® E-43 (maleated polypropylene), Epolene® G-3003 (maleated polypropylene), Epolene® G-3015 (maleated polypropylene), Epolene® C-16 (maleated polyethylene), and Epolene® C-18 (maleated polyethylene). The Epolene® series of polyolefin waxes and polymers is commercially available from Eastman Chemical Company, in Kingsport, Tenn. Epolene polymers are medium to low molecular weight polyethylene or polypropylene. They are useful in the plastics industry as lubricants for PVC, processing aids, mold release agents, dispersion aids, and coupling agents. They are also widely used as base polymers for hot-melt adhesives and pavement striping compounds as well as petroleum wax modifiers for use in candles, investment casting, cable filling, and various paperboard coatings. Numerous types of Epolene polymers are available, and properties can be selected to fit various processing operations.

Further non-limitative examples of suitable compatibilizers include Polybond® 1001, Polybond® 1002, Polybond® 1009, Polybond® 3000, Polybond® 3002, Polybond® 3009, Polybond® 3150, and Polybond® 3200. The Polybond® series is commercially available from Chemtura, USA, and are polypropylenes and/or polyethylenes functionalized with maleic anhydride. Polybond® 3150 has a MFI of 50 g/10 min, 230° C., 2.16 kg; and Polybond® 3200 has a MFI of 110 g/10 min, 190° C., 2.16 kg.

The starch can be made from any suitable source such as corn, tapioca, maize, wheat, rice or combination thereof. The starch can be in any suitable form such as, for example, a powder.

The plasticizer can be, for example, any suitable material that softens and/or adds flexibility to the materials they are added to. The plasticizers can soften the final product increasing its flexibility. Suitable plasticizer include, for example, polyethylene glycol, sorbitol, glycerine or combination thereof.

Industrial plasticizers are discussed in the Encyclopedia of Chemical Technology, 4^{th} ed., Vol 19, pp 258-280, 1997, which is incorporated herein by reference. A plasticizer is a substance which, when added to another material, increases the softness and flexibility of that material. Without being bound by theory, it is believed that plasticizers increase flexibility of polymeric materials by increasing the free volume within the material. Randomly distributed within the material and interspersed among the polymer chains, the plasticizer molecules interfere with the polymer's ability to align its chains and pack into ordered structures. Molecular ordering increases the density of the material (decreases free volume) and impedes mobility of the polymer chains within the material. The increase in free volume imparted by the plasticizer allows room for chain segments to move. The material can then more readily accommodate an applied force by deforming. Particular examples of suitable plasticizers include glycerol, diethylene glycol, sorbitol, sorbitol esters, maltitol, sucrose, fructose, invert sugars, corn syrup, and mixtures of one or more of these.

In an embodiment, the polyolefin compositions can comprise suitable amounts of one or more additional components such as, for example, stabilizers, colorants, antioxidants, flavorants, nanofillers, non-clay particles, glass-fiber reinforcements, anti-microbial agents, processing aids or combination thereof.

Some non-limitative examples of suitable stabilizers include Irganox® Antioxidant 1010, B-225, B-900, and Irgastab® FS 301 and FS 210 FF, each commercially available from Ciba Specialty Chemicals, in Tarrytown, N.Y. Some light stabilizers are commercially available from Ciba Specialty Chemicals under the tradenames CHIMASSORB®. Further available from Ciba is Tinuvin 770 DF, which is a light stabilizer belonging to the class of hindered amine light stabilizers, as well as Tinuvin® 944, Tinuvin® 123, and Tinuvin® 328. A further example of a suitable stabilizer is Organox® 168.

If a color concentrate is desired, the mixture may further include one or more colorants, such as pigment(s) and/or dye(s). Organic or inorganic filler or pigment particles can be used. The pigments may be chosen from a list including clays, calcium carbonate, titanium dioxide and synthetic organic pigments.

Nanofillers may comprise any suitable compound. In an embodiment, the nanofiller comprises an organoclay. Some non-limitative examples of suitable organoclay materials include Cloisite® Na+, Cloisite® 30B, Cloisite® 10A, Cloisite® 25A, Cloisite® 93A, Cloisite® 15A, Cloisite® 20A. The Coisite clays are proprietary nanoclays commercially available from Southern Clay Products, a subsidiary of Rockwood Specialties, Inc., located in Princeton, N.J. Suitable organoclay may also be obtained from Nanocor.

The anti-microbial agents can be metal-based agents such as zinc oxide, copper and copper compounds, silver and silver compounds, colloidal silver, silver nitrate, silver sulphate, silver chloride, silver complexes, metal-containing zeolites, surface-modified metal-containing zeolites or combination thereof. The metal-containing zeolites can comprise a metal such as silver, copper, zinc, mercury, tin, lead, bismuth, cadmium, chromium, cobalt, nickel, zirconium and combinations thereof. In another embodiment, the anti-microbial agents can be organic-based agents such as o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol and combinations thereof.

In another embodiment, the present disclosure provides a method of making a polyolefin composition. The method comprises blending a polyolefin, a compatibilizer, a starch and a plasticizer to form a mixture. The method can further comprise extruding the blended mixture into to form an extrudate. The method can also comprise shaping the extrudate to form articles such as toys, computer casing, DVDs, toiletries, combs, consumer products, cellular phone casings, bags, foam material products, packaging, automobile parts, cookware or combination thereof.

The articles can be made by any suitable process such as, for example, injection molding, thermoforming, film blowing, film extrusion, stretch blow molding, extrusion blow molding, extrusion coatings, profile extrusion, cast films, cast products or combinations thereof.

In yet another embodiment, the present disclosure provides a method of making a polyolefin composition. This method comprises blending a polyolefin and a compatibilizer to form a first mixture and blending a starch and a plasticizer to form a second mixture. The first mixture is introduced into a first feed of an extruder such as, for example, a twin screw extruder. The second mixture is introduced into the extruder at any suitable location downstream of the first feed. The second mixture becomes blended with the first mixture in the extruder. The blended mixture is eventually extruded from the extruder to form an extrudate. It should be appreciated that the first mixture and/or the second mixture can comprise one or more additional components such as, for example, stabilizers, colorants, antioxidants, flavorants, nanofillers, non-clay particles, glass-fiber reinforcements, anti-microbial agents, processing aids or combinations thereof.

The method can further comprise vacuuming the vapor phase of the blended mixture. For example, the vapor phase of the blended mixture can be released from the first mixture, the second mixture and/or the blended mixture at any point in the extruder or after being extruded. As a result, the extrudate can comprise any suitable texture or viscosity as desired.

In an alternative embodiment, the present disclosure provides a method of making a polyolefin film. The method comprises blending a polyolefin, a compatibilizer, a starch and a plasticizer to form a mixture and forming a film from the mixture. The method can further comprise applying the film to an article comprising a material selected from the group consisting of paper, plastics, wood, composite materials or combination thereof. Suitable articles can be toys, computer casing, DVDs, toiletries, combs, consumer products, cellular phone casings, bags, foam material products, packaging, automobile parts, cookware or combination thereof.

By way of example and not limitation, the following examples are illustrative of various embodiments of the present invention.

TABLE 1
Material Composition

| MATERIALS | QTY (lbs) |
|---|---|
| Blend #1 | |
| Polypropylene | 80 |
| Maleic anhydride grafted polypropylene | 10 |
| Blend #2 | |
| STARCH-corn | 90 |
| Sorbitol | 4 |
| PEG ® 8000 | 10 |
| PEG ® 2000 | 6 |
| Total weight | 200 |

### Processing Steps:

The polypropylene/starch composite was prepared on a 36:1 Length/Diameter co-rotating, intermeshing twin screw extruder of 65 mm diameter, using a temperature profile of between 130 and 170° C., at screw speeds in the range of 200-400 rpm. Throughput was in the range of 150-250 kg/hr, and the compound was water quenched and strand pelletized.

A blend of polypropylene and maleic anhydride grafted polypropylene, the compatibilizing agent, was prepared in a low shear mixer and fed to the main feeder of the twin screw extruder using a volumetric screw feeder. The starch and starch plasticizers were blended in a high speed mixer and fed into the twin screw extruder through a side feeder using another volumetric screw feeder. The extruder screw and barrel configuration was optimized to handle the large vapor quantity through back venting upstream of the side feeder. This allowed high rates to be achieved with a 50% starch blend going into the side feeder.

TABLE 2
Formulation ranges of the Polyolefin Composition
in an embodiment

| | General Range | Preferred | Most Preferred |
|---|---|---|---|
| | (by weight) | (by weight) | (by weight) |
| Polypropylene | 20-80% | 40-60% | 45-55% |
| Maleic anhydride | 1-10% | 1-7% | 2-5% |
| grafted | | | |
| polypropylene | | | |
| Starch | 10-70% | 20-60% | 25-55% |
| Sorbitol | 1-3% | 1.5-2.5% | 1.75-2.25% |
| PEG ® 8000 | 3-8% | 4-7% | 4.5-6.5% |
| PEG ® 2000 | 1-5% | 2-4% | 2.5-3.5% |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a polyolefin composition, the method comprising:
blending a polyolefin, a compatibilizer, a starch and a plasticizer to form a mixture.

2. The method of claim 1 comprising extruding the blended mixture to form an extrudate.

3. The method of claim 2 comprising shaping the extrudate to form an article selected from the group consisting of toys, computer casing, DVDs, toiletries, combs, consumer products, cellular phone casings, bags, foam material products, packaging, automobile parts, cookware and combinations thereof.

4. The method of claim 3, wherein the articles are made by a process selected from the group consisting of injection molding, thermoforming, film blowing, stretch blow molding, extrusion blow molding, extrusion coatings, profile extrusion, film extrusion, cast films, cast products and combinations thereof.

5. The method of claim 1, wherein the polyolefin is selected from the group consisting of polyethylene, polypropylene, polybutene and combinations thereof.

6. The method of claim 5, wherein the polyethylene is selected from the group consisting of low density polyethylene, high density polyethylene, linear low density polyethylene and combinations thereof.

7. The method of claim 1, wherein the compatibilizer is selected from the group consisting of maleic anhydride grafted polypropylene, maleic anhydride grafted polyethylene, maleic anhydride grafted polybutene and combinations thereof.

8. The method of claim 1, wherein the compatibilizer comprises maleated polypropylene with a melt flow of about 50 to about 500 g/10 minute and maleic anhydride grafting of about 0.5 to about 10 wt %.

9. The method of claim 1, wherein the starch is selected from the group consisting of corn, tapioca, maize, wheat, rice and combinations thereof.

10. The method of claim 1, wherein the plasticizer is selected from the group consisting of polyethylene glycol, sorbitol, glycerine and combinations thereof.

11. The method of claim 1 further comprising at least one component selected from the group consisting of stabilizers, colorants. antioxidants, flavorants, nanofillers, non-clay particles, glass-fiber reinforcements, anti-microbial agents, processing aids and combinations thereof.

12. A method of making a polyolefin composition, the method comprising:
blending a polyolefin and a compatibilizer to form a first mixture;
blending a starch and a plasticizer to form a second mixture;
feeding the first mixture into a first feed of an extruder;
feeding the second mixture into the extruder at a location downstream of the first feed, the second mixture blending with the first mixture;
extruding the blended mixture to form an extrudate.

13. The method of claim 12 comprising vacuuming the vapor phase of the blended mixture.

14. The method of claim 12, wherein at least one of the first mixture and the second mixture comprises at least one component selected from the group consisting of stabilizers, colorants, antioxidants, flavorants, nanofillers, non-clay particles, glass-fiber reinforcements, anti-microbial agents, processing aids and combinations thereof.

15. A method of making a polyolefin film, the method comprising:
blending a polyolefin, a compatibilizer, a starch and a plasticizer to form a mixture; and
forming the film from the mixture.

16. The method of claim 15 comprising applying the film to an article comprising a material selected from the group consisting of paper, plastics, wood, composite materials and combinations thereof.
